(19) United States
(12) Patent Application Publication
(10) Pub. No.: US 2017/0255580 A1
(43) Pub. Date: Sep. 7, 2017

(54) MULTI-MODAL INPUT SYSTEM FOR A COMPUTER SYSTEM

(71) Applicants: DEVANG R. PAREKH, SAN DIEGO, CA (US); HENRY H. FUNG, SAN DIEGO, CA (US); WAYNE KIM, SAN DIEGO, CA (US); LOUIS ODDO, CARLSBAD, CA (US); FENG CAO, SAN DIEGO, CA (US); PAUL DOMINGUEZ, SAN DIEGO, CA (US); BENJAMIN MONTGOMERY, SAN DIEGO, CA (US); PETER FONG, SAN DIEGO, CA (US)

(72) Inventors: DEVANG R. PAREKH, SAN DIEGO, CA (US); HENRY H. FUNG, SAN DIEGO, CA (US); WAYNE KIM, SAN DIEGO, CA (US); LOUIS ODDO, CARLSBAD, CA (US); FENG CAO, SAN DIEGO, CA (US); PAUL DOMINGUEZ, SAN DIEGO, CA (US); BENJAMIN MONTGOMERY, SAN DIEGO, CA (US); PETER FONG, SAN DIEGO, CA (US)

(73) Assignee: NORTHROP GRUMMAN SYSTEMS CORPORATION, FALLS CHURCH, VA (US)

(21) Appl. No.: 15/058,839

(22) Filed: Mar. 2, 2016

(51) Int. Cl. G06F 13/38; G06F 9/54; G06F 13/42

(52) U.S. Cl. CPC G06F 13/385; G06F 13/4282; G06F 9/54

(57) ABSTRACT

One example includes a computer system. Ports each receive signals corresponding to an interface input associated with user physical interaction provided via an interface device in one of disparate input modes. A multi-modal input system maps an interface input associated with one of the ports provided in a given one of the disparate input modes into a computer input command, maps an interface input associated with another of the ports provided in another one of the disparate input modes into another computer input command, and aggregates the computer input commands into a multi-modal event command. A processor executes a single predetermined function associated with the computer system in response to the multi-modal event command. Thus, the processor is configured to execute the single predetermined function associated with the computer system in response to user physical interaction provided in at least two of the plurality of disparate input modes.

### TECHNICAL FIELD

The present invention relates generally to computer systems, and specifically to a multi-modal input system for a computer system.

### BACKGROUND

As the range of activities accomplished with a computer increases, new and innovative ways to provide an interface with a computer are often developed to complement the changes in computer functionality and packaging. For example, touch sensitive screens can allow a user to provide inputs to a computer without a mouse and/or a keyboard, such that desk area is not needed to operate the computer. Examples of touch sensitive screens include pressure sensitive membranes, beam break techniques with circumferential light sources and sensors, and acoustic ranging techniques. However, these types of computer interfaces can only provide information to the computer regarding the touch event, itself, and thus can be limited in application. Traditional computer input devices can be time-consuming, particularly in computing applications that can require rapid response to changes in feedback information via a display system to one or more users. Furthermore, large computing environments can require inputs from disparate sources and/or concurrent control.

### SUMMARY

One example includes a computer system. Ports each receive signals corresponding to an interface input associated with user physical interaction provided via an interface device in one of disparate input modes. A multi-modal input system maps an interface input associated with one of the ports provided in a given one of the disparate input modes into a computer input command, maps an interface input associated with another of the ports provided in another one of the disparate input modes into another computer input command, and aggregates the computer input commands into a multi-modal event command. A processor executes a single predetermined function associated with the computer system in response to the multi-modal event command. Thus, the processor is configured to execute the single predetermined function associated with the computer system in response to user physical interaction provided in at least two of the plurality of disparate input modes.

Another example includes a method for providing input to a computer system. The method includes converting a first physical input action provided by a user in a first input mode via a first interface device into a first interface input based on a first API associated with the first interface device and mapping the first interface input to a first computer input command associated with a native schema of the computer system. The method also includes converting a second physical input action provided by the user in a second input mode via a second interface device into a second interface input based on a second API associated with the second interface device and mapping the second interface input to a second computer input command associated with the native schema of the computer system. The method further includes aggregating the first computer input command and the second computer input command into a multi-modal event command and executing a single predetermined function associated with the respective computer system in response to the multi-modal event command.

Another example includes a computer system. The system includes a processor and a plurality of ports that are each coupled to one of a respective plurality of interface devices configured to receive user physical interaction provided in one of a respective plurality of disparate input modes. The system also includes a multi-modal input system. The multi-modal input system includes a deconfliction engine configured to convert the user physical interaction associated with each of the plurality interface devices into a respective plurality of interface inputs via a plurality of APIs associated with the respective plurality of interface devices, and to map the plurality of interface inputs into a respective plurality of computer input commands associated with a native schema of the computer system. The multi-modal input system also includes a multi-modal command aggregation controller configured to aggregate the plurality of computer input commands into a multi-modal event command based on comparing a timer value associated with a modality timer with a predetermined threshold timer value. The system also includes a processor configured to execute a single predetermined function associated with the computer system in response to the multi-modal event command, such that the processor is configured to execute the single predetermined function associated with the computer system in response to user physical interaction provided in at least two of the plurality of disparate input modes.

### BRIEF DESCRIPTION OF THE DRAWINGS

FIG. 1 illustrates an example of a computer input system.

FIG. 2 illustrates an example diagram of interface devices for a computer input system.

FIG. 3 illustrates an example diagram of operation of a multi-modal command aggregation controller.

FIG. 4 illustrates an example diagram of a federated mission management system.

FIG. 5 illustrates an example of a method for providing input to a computer system.

### DETAILED DESCRIPTION

The present invention relates generally to computer systems, and specifically to a multi-modal input system for a computer system. The multi-modal input system can provide for a more intuitive manner of providing inputs to a computer system using a combination of different input modes. As described herein, the term “input mode” refers to a specific manner of providing inputs to a computer through human interaction with the computer system. Examples of input modes include traditional computer inputs, such as keyboard, mouse, and touch-screen inputs, as well as non-traditional computer inputs, such as voice inputs, gesture inputs, head and/or eye-movement, laser inputs, radio-frequency inputs, or a variety of other different types of ways of providing an input to a computer system. The multi-modal input system can be configured to recognize human (i.e., “user”) interaction (e.g., physical input action) with an interface device to provide a respective interface input. The interface input can be generated, for example, from an application programming interface (API) that is preprogrammed to translate specific human interactive actions into respective specific inputs corresponding to specific functions. The interface input can thus be translated into a computer input command associated with a native schema of the computer system via command mapping adapters. As described herein, the term “native schema” corresponds to machine language understood by the computer system, such that the computer input commands are understood by the software and/or firmware of the computer system to implement specific respective functions. Thus, the interface inputs can be provided to implement the specific functions of the computer system by mapping the human interaction into the interface input via the respective API and by mapping the interface input into the computer input command understood by the computer system via the command mapping adapters.

The multi-modal input system can thus generate a multi-modal event command that is an aggregation of two or more computer input commands that are provided to the computer system in different input modes, with the multi-modal event command corresponding to implementation of a separate respective function for the computer system. As an example, the multi-modal event command can be generated to implement a specific function for the computer system that cannot quickly or easily be performed using a single computer input command corresponding to a single input mode. For example, the multi-modal event command can correspond to an aggregation of a voice input and a gesture input to provide a given command to the computer system to implement a specific function. As an example, the multi-modal event command can be a discrete multi-modal event command corresponding to single function implementation. As another example, the multi-modal event command can correspond to an activation command to initiate a sustained input event, such that additional computer input commands can be provided via one or more of the input modes, with each computer input command corresponding to a single function implementation, during the duration of the sustained input event. Accordingly, the multi-modal input system can be configured to facilitate rapid and intuitive inputs to the computer system, such as for a computer system that controls a very large number of parameters (e.g., a federated mission management system).

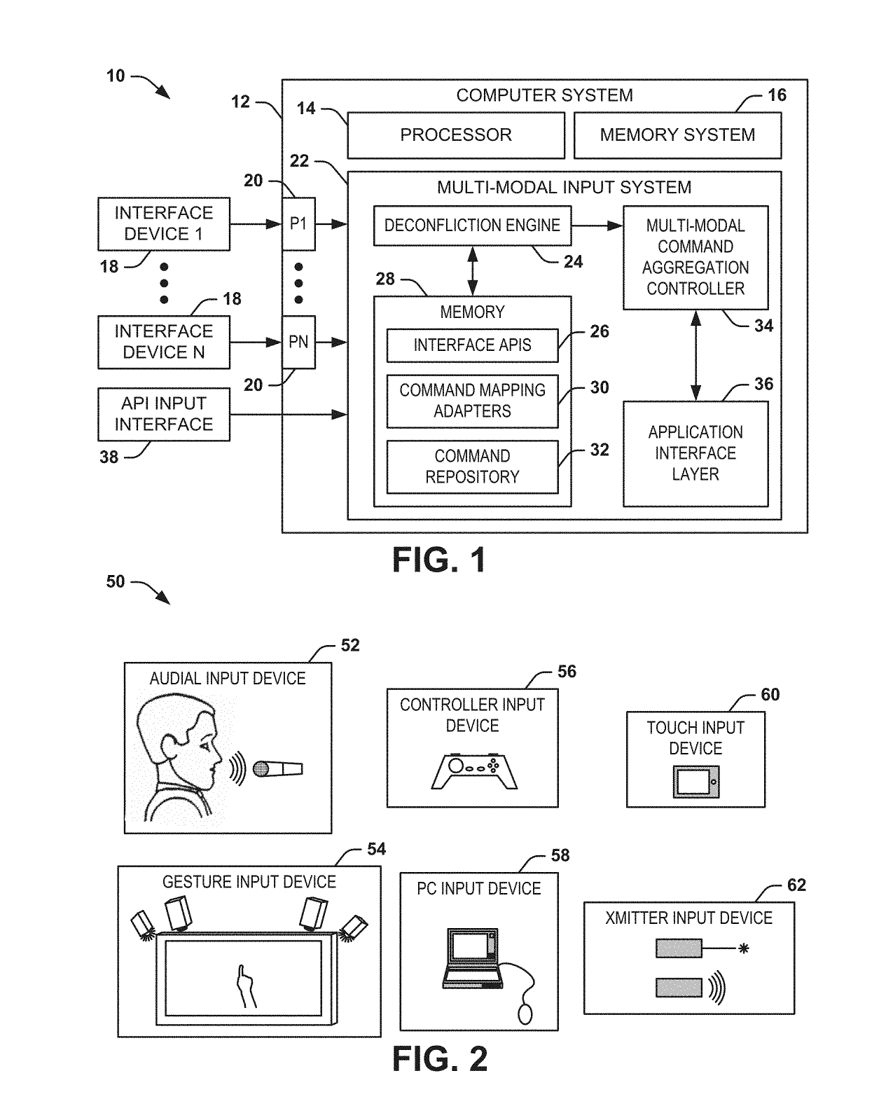

FIG. 1 illustrates an example of a computer input system 10. The computer input system 10 is associated with providing input to a computer system 12 that can be used in a variety of different computing environments, from personal computer, such as including desktop computers, laptop computers, tablet computers, and/or other wireless devices, to enterprise server computers or collections of networked computers. The computer system 12 includes a processor 14 and a memory system 16. As an example, the computer input system 10 can be implemented for controlling a federated mission management system, such as to control a large number of mission assets in a military, search-and-rescue, dispatch, or other application that requires control of a large number of separate mission assets over a geographic area.

The computer input system 10 includes a plurality N of interface devices 18 that are plugged into a plurality N of ports 20 (“P1” through “PN”), where N is a positive integer. The interface devices 18 can each correspond to a device, collection of devices, station, or other types of hardware that are configured to provide a signal or signals in response to user physical interaction that can each be plugged-into or otherwise coupled (e.g., wire or wirelessly) to separate respective ports of the multi-modal input system 22. As described herein, the terms “user physical interaction” and “user physical input action” are interchangeable. As an example, each of the interface devices 18 can correspond to different input modes, and thus can each provide a separate manner of providing a signal or signals in response to user physical interaction. Examples of the input modes that can be employed by the interface devices 18 can include traditional computer inputs, such as keyboard, mouse, and touch-screen inputs to provide signals in response to movement of digits of the user in contact with hardware. Other types of input modes that can be employed by the interface devices 18 can include non-traditional computer inputs, such as voice inputs, gesture inputs, head and/or eye-movement, laser inputs, radio-frequency inputs, or a variety of other different types of ways of providing an input.

FIG. 2 illustrates an example diagram 50 of interface devices for the computer input system 10. The interface devices demonstrated in the diagram 50 can each correspond to one of the interface devices 18 in the example of FIG. 1.

The diagram 50 demonstrates an audial input device 52 corresponding to a microphone that is responsive to audial commands provided from the user. As an example, the audial commands can correspond to specific predetermined voice strings, such as one or more words spoken by the user into the audial input device 52. As another example, the audial commands can be sound effects provided by the user via the mouth (e.g., a “shush” sound) or via the body (e.g., a “clap” or “click” sound using one or more of the hands of the user). Thus, the audial input device 52 can provide signals corresponding to human interaction in the form of sound.

The diagram 50 also demonstrates a gesture input device 54 corresponding to a gesture recognition system that is responsive to gesture commands provided from the user. As an example, the gesture input device 54 can be configured to recognize hand-gestures provided by the user, such as gestures provided via the user's naked hand provided over a retroreflective background screen (e.g., in a touchless manner) based on a set of stereo cameras and light sources (e.g., infrared light). As another example, the user can provide the gestures using a sensor-glove or other powered input device (e.g., a stylus). As yet another example, the gesture input device 54 can be associated with other input modes, such as head-movement, shoulder shrugging, leg-movement, or other body motion. Thus, the gesture input device 54 can provide signals corresponding to human interaction in the form of hand gestures and/or body-language.

The diagram 50 also includes a controller input device 56 corresponding to a controller device that is responsive to hand manipulation provided from one or both hands of the user. The controller input device 56 can correspond to a multi-input device that includes both analog and digital controls that a user can manipulate via fingers and hands, such as including buttons, a flight-stick, a joystick, a touchpad, or any other input component on a controller. As an example, the controller input device 56 can be specifically designed for a given input application, such as a piloting controller that emulates a piloting controller of an actual aircraft. As another example, the controller input device 56 can correspond to any of a variety of third-party, off-the-shelf controllers that can be adapted for any of a variety of input purposes, such as console game-system controllers. Thus, the controller input device 56 can provide signals corresponding to human interaction in the form of button pressing and/or analog movements of a joystick or touchpad.

The diagram 50 also includes a personal computer (PC) input device 58 corresponding to any of a variety of typical PC interface devices that are responsive to hand manipulation provided from one or both hands of the user. The PC input device 58 can correspond to a keyboard, a mouse, or any other PC input device. As described herein, the PC input device 58 corresponds to a single input mode, regardless of the inclusion of multiple different types of input devices. Thus, the PC input device 58 can provide signals corresponding to human interaction in the form of button pressing of a keyboard and/or analog movements of a mouse.

The diagram 50 also includes a touch input device 60 corresponding to any of a variety of touchscreen interfaces that are responsive to hand manipulation provided from one or both hands of the user. The touch input device 60 can correspond to a touch-sensitive display screen that is arranged to display visual content and receive touch inputs. For example, the touch inputs can be provided via capacitive sensing, break-beam sensing, pressure sensing, or a variety of other touch-sensitive implementation methods. Thus, the touch input device 60 can provide signals corresponding to human interaction in the form of pressing a touch-sensitive screen.

The diagram 50 also includes a transmitter (“XMITTER”) input device 62 corresponding to a signal transmission device, such as can be handheld by the user. For example, the transmitter input device 62 can include a laser-pointer and/or a radio-frequency (RF) transmitter device that can be tuned to be received by the computer system 12. For example, laser-pointer can be provided to a specific photo-sensitive input of the computer system, or the RF transmitter device can be activated at a specific frequency, to provide an input to the computer screen. Thus, the transmitter input device 62 can provide signals corresponding to human interaction in the form of button pressing to activate an optical or an RF signal that is received by the computer.

Referring back to the example of FIG. 1, the computer input system 10 also includes a multi-modal input system 22. The multi-modal input system 22 can be, for example, stored in the memory system 16, and is configured to receive the signal(s) provided by the interface devices 18 via the ports 20 and to convert the user physical interaction associated with two or more of the interface devices into a multi-modal event command to implement a particular computer function. As described herein, the term “multi-modal event command” describes a single computer command that implements a single computer function or action based on a combination of two or more discrete computer input commands that are separately and individually recognized by the computer system 12. As an example, one or more of the multiple discrete computer input commands can initiate a separate dedicated function with respect to the computer system 12 that is separate from the multi-modal event command. In the example of FIG. 1, the multi-modal input system 22 includes a deconfliction engine 24. The deconfliction engine 24 is configured to recognize the signal(s) corresponding to the interaction (e.g., physical input action) with a given interface device 18 and to provide a corresponding respective interface input. The deconfliction engine 24 is configured to access a set of interface application programming interfaces (APIs) 18 from a memory 28 in response to receiving the signal(s) from the respective interface device(s) 12 resulting from user physical input actions. As an example, the memory 28 can be associated with the memory system 16.

The interface APIs 26 are preprogrammed to translate the signal(s) corresponding to the specific human interactive actions from the respective interface devices 18 into respective interface inputs corresponding to specific functions associated with the computer system 12. Additionally, the deconfliction engine 24 can reject signal(s) that result from spurious actions provided through a respective interface device 18. For example, the deconfliction engine 24 can determine if signals from a gesture interface device (e.g., the gesture input device 54) or a voice interface device (e.g., the audial input device 52) of the interface devices 18 correspond to predetermined interface inputs via the interface APIs 26. Thus, the deconfliction engine 24 can be configured to discern unintended actions that can be provided via one or more of the interface devices 18 with intended physical input actions provided by the user via the interface APIs 26.

The memory 28 also includes a set of command mapping adapters 30 that are accessible by the deconfliction engine 24 to translate interface inputs into respective computer input commands associated with a native schema of the computer system 12. In the example of FIG. 1, the memory 28 also includes a command repository 32 that is configured to store a set of the computer input commands corresponding to computer functions in the native schema of the computer system 12. As an example, the command repository 32 can be customizable, as described in greater detail herein, and thus can be programmable to include new computer input commands that can correspond to the interface inputs provided by one or more of the interface devices 18 via the interface APIs 26. Accordingly, the command mapping adapters 30 can be implemented by the deconfliction engine 24 to generate the computer input commands that can correspond to the computer inputs that are desired in response to the user physical interaction provided via the interface devices 18.

The multi-modal input system 22 also includes a multi-modal command aggregation controller 34. The multi-modal command aggregation controller 34 is configured to aggregate a plurality of the computer input commands provided via the command mapping adapters 30 into a multi-modal event command. As described herein, the term “multi-modal event command” describes a single computer input that is generated based on a combination of multiple interface inputs provided via a respective multiple different input modes. Therefore, the multi-modal event command is configured to implement a predetermined function associated with the computer system 12. As an example, the multi-modal event command can be a discrete multi-modal event, such that the multi-modal event command implements a single discrete command to the computer system 12 to implement a respective single function. As another example, the multi-modal event command can be an activation command to initiate a sustained input event, such that additional computer input commands provided via the interface devices 18 can implement respective functions with respect to the computer system 12 during the sustained input event, as described in greater detail herein.

In the example of FIG. 1, the multi-modal event command is provided to an application interface layer 36 that is configured to interpret the multi-modal event command in the native schema of the computer system 12 and to implement the predetermined function of the computer system 12 corresponding to the multi-modal event command. Based on the implementation of multi-modal event commands that are based on interface inputs provided via the interface devices 18, the multi-modal input system 22 can allow for intuitive command aggregation to facilitate groupings of commands to portray specific events in an input environment, such as to control a federated mission management system. For example, the computer input system 10 can be implemented to control a federated mission management system that includes a fleet of mission assets, such as including unmanned aerial vehicles (UAVs), in an efficient manner.

In addition, the multi-modal input system 22 includes an API interface device 38. The API interface device 38 is configured as a programming interface to facilitate additional interface APIs 26, command mapping adapters 30, and computer input commands for the command repository 32. Therefore, a user can implement the API interface device 38 as a computer terminal, a graphical user interface (GUI) on a website, or as a plug-in port to install the additional interface APIs 26, command mapping adapters 30, and/or computer input commands for the command repository 32 to be stored in the memory 28. Accordingly, the multi-modal input system 22 can be scalable and customizable to allow for the addition of new and useful interface devices 18, or new and useful ways of converting human interaction into interface inputs using the interface devices 18.

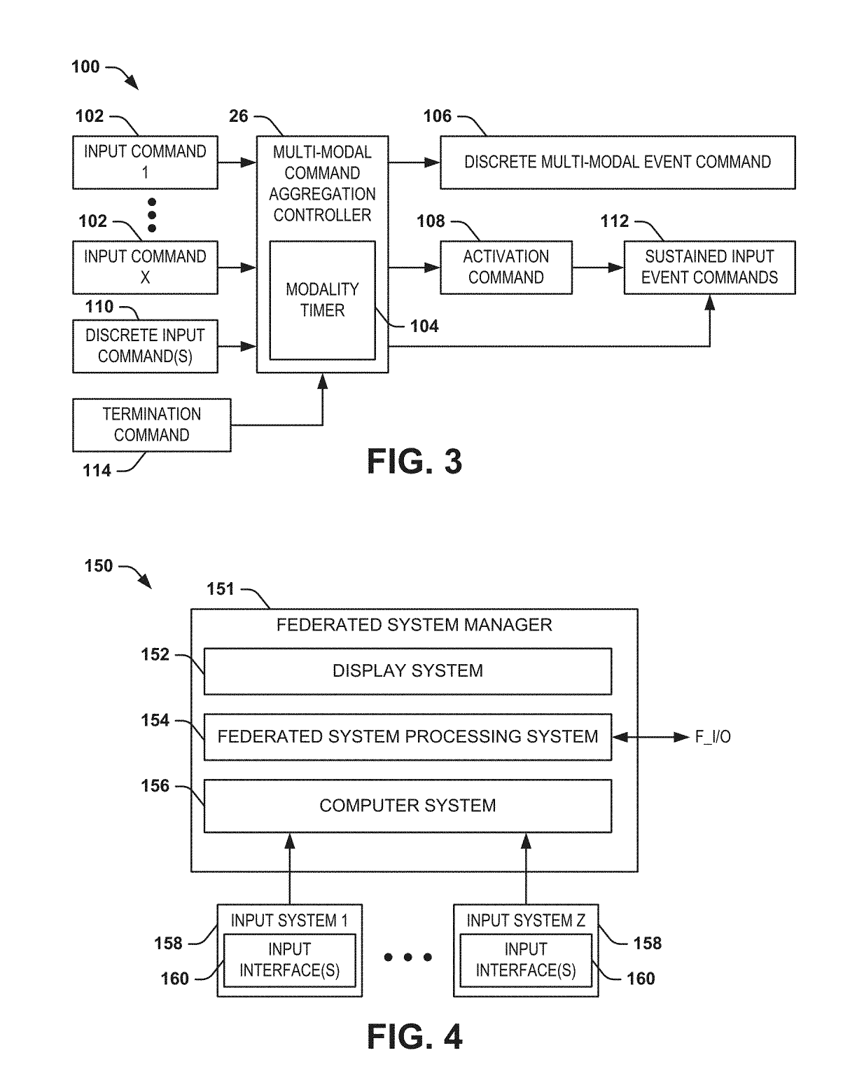

FIG. 3 illustrates an example diagram 100 of operation of the multi-modal command aggregation controller 34. The diagram 100 depicts function blocks that can correspond to specific actions and functionality taken by the multi-modal command aggregation controller 34, as well as depicting hardware and/or software elements. Thus, reference is to be made to the example of FIG. 1 in the following description of the example of FIG. 3.

The diagram 100 includes a plurality X of computer input commands 102 having been provided to the multi-modal command aggregation controller 34 from the deconfliction engine 24, where X is a positive integer. As an example, X can be two, such that the computer input commands 102 correspond to a combination of two interface inputs having been provided via a respective two of the interface devices 18 and converted to two respective computer input commands via the interface APIs 26 and the command mapping adapters 30, respectively. For example, a first of the computer input commands 102 can be a computer input command corresponding to a voice interface input generated at the audial input device 52 and a second of the computer input commands 102 can be a computer input command corresponding to a gesture interface input generated at the gesture input device 54.

The computer input commands 102 are provided to the multi-modal command aggregation controller 34. In the example of FIG. 3, the multi-modal command aggregation controller 34 includes a modality timer 104 that is configured to determine a relative time between the receipt of the computer input commands 102. For example, the multi-modal command aggregation controller 34 can be configured to initiate the modality timer 104 in response to receiving a first of the computer input commands 102. In response to receiving a second of the computer input commands 102 within a predetermined threshold time, the multi-modal command aggregation controller 34 can be configured to determine if the combination of the first and second computer input commands 102 correspond to a multi-modal event command. If the count value of the modality timer 104 exceeds the predetermined threshold time, the multi-modal command aggregation controller 34 can determine that no multi-modal event command is intended, or that the attempt on a multi-modal event command failed. However, if the multi-modal command aggregation controller 34 determines that the computer input commands 102 that are received within the predetermined threshold time correspond to a multi-modal event command, the multi-modal command aggregation controller 34 initiates the multi-modal event command.

As an example, the multi-modal event command can correspond to a discrete multi-modal event command 106 corresponding to initiation of a single computer function of the computer system 12. Therefore, in response to executing a discrete multi-modal event command 106, the multi-modal command aggregation controller 34 can await a next set of computer input commands 102 to determine if the next set of computer input commands 102 correspond to another multi-modal event command (e.g., another discrete multi-modal event command 106), such as via the modality timer 104. Thus, in response to receiving a plurality of computer input commands 102 within the predetermined threshold time, the multi-modal command aggregation controller 34 can determine that the plurality of computer input commands 102 correspond to the discrete multi-modal event command 106 (e.g., via the application interface layer 36), and can provide the discrete multi-modal event command 106 to implement a single computer function of the computer system 12.

As another example, the multi-modal event command can correspond to an activation command 108. The activation command 108 can correspond to activation of a sustained input event that facilitate rapid single computer functions in response to discrete computer input commands 110. The discrete computer input commands 110, though depicted as different elements in the diagram 100 of the example of FIG. 3, can correspond to any of the computer input commands 102 that are provided via any of the interface devices 18 in the example of FIG. 1 (e.g., any of the interface devices in the diagram 50 in the example of FIG. 2). However, during the sustained input event, each individual discrete computer input command 110 can be translated by the multi-modal command aggregation controller 34 as a sustained input event command 112 to provide a corresponding respective computer function. As an example, in response to providing the activation command 108 to initiate the sustained input event, the multi-modal command aggregation controller 34 can activate the modality timer 104. If the next discrete computer input command 110 received is within a predetermined threshold time, such as can differ from the predetermined threshold time associated with determining the occurrence of a multi-modal event command, the multi-modal command aggregation controller 34 can translate the next discrete computer input command 110 into a sustained input event command 112. However, if no discrete computer input command 110 is received within the predetermined threshold time, the multi-modal command aggregation controller 34 can terminate the sustained input event.

Thus, in response to receiving a plurality of computer input commands 102 within the predetermined threshold time, the multi-modal command aggregation controller 34 can determine that the plurality of computer input commands 102 correspond to the activation command 108 (e.g., via the application interface layer 36). In response, the multi-modal command aggregation controller 34 can initiate the sustained input event. Accordingly, during the sustained input event, in response to receiving a single discrete computer input command 110, the multi-modal command aggregation controller 34 can translate the single discrete computer input command 110 into a sustained input event command 112 (e.g., via the application interface layer 36) to implement a single computer function of the computer system 12. The multi-modal command aggregation controller 34 can thus continue to translate the discrete computer input commands 110 into the sustained input event commands 112 on a one-for-one basis during the sustained input event until the sustained input event is terminated. As an example, during the sustained input event, the multi-modal command aggregation controller 34 can only be configured to translate discrete single computer input commands 110 into the sustained input event commands 112, such that the multi-modal command aggregation controller 34 can ignore attempts to provide a multi-modal event command that is translated to a discrete multi-modal event command 106. Alternatively, as another example, during the sustained input event, the multi-modal command aggregation controller 34 can limit the sustained input event commands 112 that can be provided, and can still receive plural computer input commands 102 that can correspond to a multi-modal event command that is translated to a discrete multi-modal event command 112.

Additionally, in the example of FIG. 3, the multi-modal command aggregation controller 34 can receive a termination command 114. As an example, the termination command 114, though depicted as different elements in the diagram 100 of the example of FIG. 3, can correspond to a specific computer input command 102 that is provided via any of the interface devices 18 in the example of FIG. 1 (e.g., any of the interface devices in the diagram 50 in the example of FIG. 2). Alternatively, the termination command 114 can be provided as a plurality of computer input commands 102, such that the termination command 114 can likewise correspond to a multi-modal event command. Regardless, in response to the termination command 114, the multi-modal command aggregation controller 34 can terminate the sustained input event. Therefore, the user(s) of the computer input system 10 can terminate a sustained input event without having to wait for expiration of the modality timer 104 to the predetermined threshold time.

The diagram 100 in the example of FIG. 3 thus demonstrates an example of a manner of providing a plurality of computer input commands 102 to either activate discrete multi-modal event commands 106 or discrete sustained input event commands 112 during a sustained input event. Accordingly, the computer input system 10 provides a flexible manner of providing for intuitive command aggregation to facilitate groupings of commands, such as to portray specific events in an input environment.

FIG. 4 illustrates an example of a federated mission management system 150. The federated mission management system 150 can correspond to management of a federated system that implements different sets of tools that collectively are tasked with accomplishing one or more mission objectives. As an example, the federated mission management system 150 can be configured to control and monitor a mission being performed by one or more mission assets. The mission assets can correspond to a variety of different physical mission assets that are implemented to provide specific actions to accomplish the mission objectives. As an example, the mission assets can include manned assets, such as vehicles (e.g., airborne vehicles, terrestrial vehicles, and/or nautical vehicles) and/or personnel (e.g., soldiers, reconnaissance personnel, supporting personnel, etc.), as well as unmanned assets, such as satellites, unmanned aerial vehicles (UAVs), or other unmanned vehicles. For example, the federated mission management system 150 can correspond to the federated mission management system described in U.S. patent application Ser. No. 14/992,572, Attorney Docket No. NG(ST)024628 US PRI, which is incorporated herein by reference in its entirety.

In the example of FIG. 4, the federated mission management system 150 includes a federated system manager 151 that includes a display system 152, a federated system processing system 154, and a computer system 156. The display system 152 can be configured to display mission status information regarding the one or more mission assets operating in a geographic region of interest. Therefore, the display system 152 can provide visual feedback to the user(s) of the federated mission management system 150. The federated system processing system 154 can be configured to transmit control information to the mission asset(s) and receive situational awareness data from the mission asset(s), demonstrated in the example of FIG. 4 as a signal F_I/O. Thus, in response to receiving situational awareness data, the federated system processing system 154 can provide visual indications of the situational awareness of the mission asset(s) to the user(s) of the federated mission management system 150. In response to the situational awareness, the user(s) of the federated mission management system 150 can provide control inputs via the computer system 156 to provide the control data to the mission asset(s), as described in greater detail herein.

The computer system 156 can be configured substantially similar to the computer system 12 in the example of FIG. 1. Therefore, the computer system 156 can include the multi-modal input system 22. Accordingly, the computer system 156 can include the deconfliction engine 24, the multi-modal command aggregation controller 34, and the application layer interface 30, and can be configured to provide discrete multi-modal event commands and activation commands to initiate a sustained input event for controlling the parameters of the mission (e.g., providing the control data to the mission asset(s)).

In the example of FIG. 4, the federated mission management system 150 includes a plurality Z of input systems 158, where Z is a positive integer. Each of the input systems 158 includes one or more interface devices 160, with each of the interface devices 160 corresponding to the interface devices 18 in the example of FIG. 1. As an example, each of input systems 158 can correspond to a workstation for a given one user of the federated mission management system 150, with each of the interface device(s) 160 corresponding to an interface device of a given one input mode. The interface devices 160 can thus correspond to one or more of the interface devices in the diagram 50 of the example of FIG. 2, and can thus include traditional computer inputs, such as keyboard, mouse, and touch-screen inputs, as well as non-traditional computer inputs, such as voice inputs, gesture inputs, head and/or eye-movement, laser inputs, radio-frequency inputs, or a variety of other different types of ways of providing an input to the federated system manager 151.

As an example, at least one of the input systems 158 can include a plurality of interface devices 160 having a respective plurality of input modes. Therefore, a user of one of the input systems 158 can be able to provide a multi-modal event command from the respective input system 158 based on providing interaction with a plurality of interface devices 160 of different input modes. As another example, multiple users can collaborate to generate a multi-modal event command via a respective plurality of interface devices 160 associated with a plurality of input systems 158. For example, a first user can provide an physical input action via one of the interface devices 160 of a respective one of the input systems 158, and a second user can provide an physical input action via another one of the interface devices 160 of a respective other one of the input systems 158. The computer system 156 can receive the separate respective physical input actions from the interface device(s) 160 of the multiple input systems 158 to generate a single multi-modal event command. Similarly, the multi-modal event command that is generated can correspond to an activation command to initiate a sustained input event to provide the capability of the user(s) to provide discrete computer input command(s) via the input systems 158, either individually, selectively, or collectively. Therefore, the input systems 158 can facilitate generation of multi-modal event commands via multiple input systems 158 that each have one or more interface devices 160 for multiple users in a collaborative control environment.

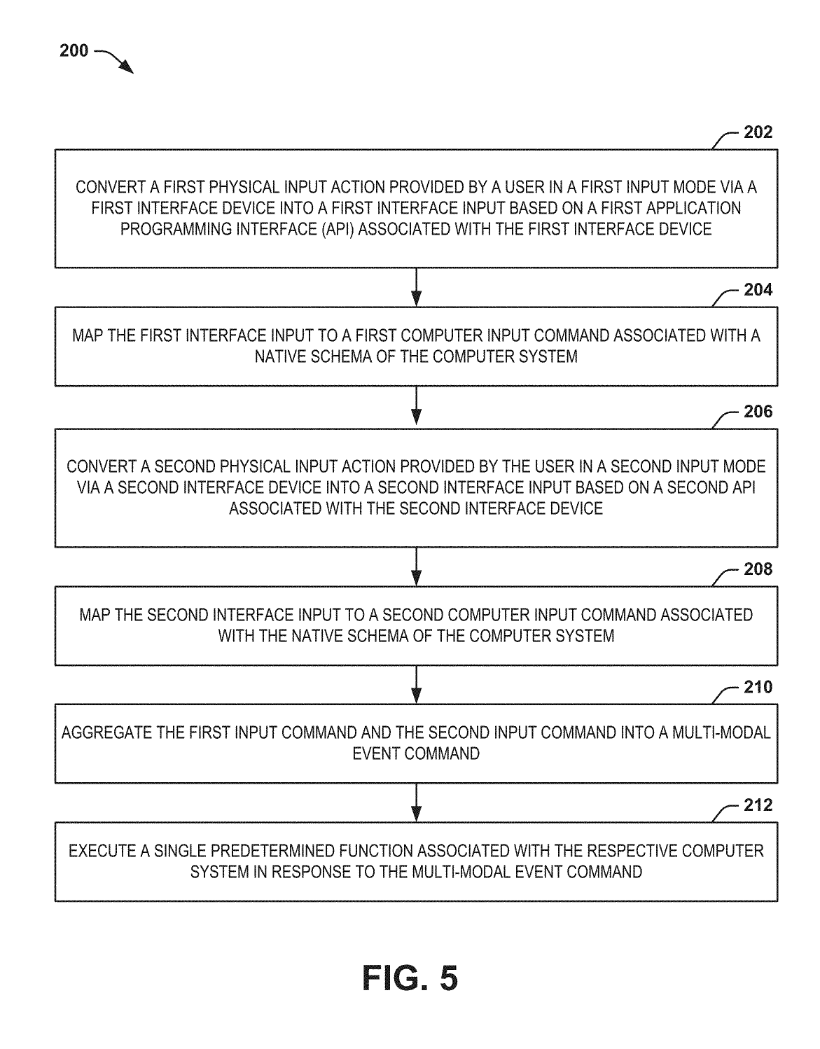

In view of the foregoing structural and functional features described above, a methodology in accordance with various aspects of the present invention will be better appreciated with reference to FIG. 5. While, for purposes of simplicity of explanation, the methodology of FIG. 5 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect of the present invention.

FIG. 5 illustrates an example of a method 200 for providing a multi-modal event command. At 202, a first physical input action provided by a user in a first input mode is facilitated (e.g., via one of the interface devices 18). At 204, the first physical input action is converted into a first interface input based on a first API (e.g., one of the interface APIs 26) associated with the first input mode. At 206, the first interface input is mapped to a first computer input command associated with a native schema of a respective computer system (e.g., via one of the command mapping adapters 30). At 208, a second physical input action provided by the user in a second input mode is facilitated (e.g., via another one of the interface devices 18). At 210, the second physical input action is converted into a second interface input based on a second API (e.g., another one of the interface APIs 26) associated with the second input mode. At 212, the second interface input is mapped to a second computer input command associated with the native schema of the respective computer system (e.g., via another one of the command mapping adapters 30). At 214, the first computer input command and the second computer input command are aggregated into a multi-modal event command (e.g., via the multi-modal command aggregation controller 34). At 216, a predetermined function associated with the respective computer system is implemented in response to the multi-modal event command.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A computer system comprising:
a processor;
a plurality of ports that are each configured to receive signals corresponding to an interface input associated with user physical interaction provided via one of a respective plurality of interface devices in one of a respective plurality of disparate input modes; and
a multi-modal input system configured to map an interface input associated with one of the plurality of ports that is provided in a given one of the plurality of disparate input modes into a given one of a plurality of computer input commands, to map an interface input associated with another one of the plurality of ports that is provided in another one of the plurality of disparate input modes into another one of the plurality of computer input commands, and to aggregate the given one and the other one of the plurality of computer input commands into a multi-modal event command, the processor being configured to execute a single predetermined function associated with the computer system in response to the multi-modal event command, such that the processor is configured to execute the single predetermined function associated with the computer system in response to user physical interaction provided in at least two of the plurality of disparate input modes.

2. The system of claim 1, wherein the multi-modal input system comprises a deconfliction engine configured to provide mapping of the plurality of interface inputs into the respective plurality of computer input commands associated with the native schema of the computer system, wherein the deconfliction engine comprises a command repository configured to store the plurality of computer input commands associated with the native schema of the computer system.

3. The system of claim 2, wherein the multi-modal input system comprises a plurality of application programming interface (API)s associated with the respective plurality of ports and being configured to convert the signals associated with the user physical interaction into the interface input associated with each of the plurality of ports.

4. The system of claim 3, wherein the multi-modal input system comprises a memory configured to store the plurality of APIs, and to facilitate storage of additional APIs that can be programmed via a programmable API input controller.

5. The system of claim 1, wherein the multi-modal input system comprises a multi-modal command aggregation controller configured to aggregate the plurality of computer input commands into the multi-modal event command configured to implement the predetermined function associated with the computer system based on a modality timer that compares a relative time at which each of the plurality of computer input commands are received to a predetermined threshold.

6. The system of claim 5, wherein the multi-modal event command is an activation command configured to initiate a sustained input event in which each of a plurality of successive interface inputs are mapped to a respective plurality of successive computer input commands to implement a respective plurality of predetermined functions associated with the computer system during the sustained input event.

7. The system of claim 6, wherein at least one of the plurality of interface devices is configured to facilitate a termination input via the user physical interaction, wherein the multi-modal input system is configured to map the termination input into a termination command to terminate the sustained input event.

8. The system of claim 6, wherein the modality timer is configured to initiate an inactivity time during the sustained input event between each of the plurality of successive interface inputs, wherein the multi-modal command aggregation controller is configured to terminate the sustained input event in response to the inactivity timer achieving a predetermined threshold time.

9. The system of claim 1, wherein a first of the plurality of interface devices is associated with a gesture interface device in a gesture input mode corresponding to user facilitated changes to a location of a gesture input object in three-dimensional space, and wherein a second of the plurality of interface devices is associated with a voice interface device in a voice input mode corresponding to a user facilitated speech pattern provided to a microphone, such that the multi-modal input system is configured to aggregate first and second computer input commands into the multi-modal event command configured to implement the predetermined function associated with the computer system.

10. The system of claim 1, wherein the computer input system comprises a plurality of multi-modal input systems that are each configured to receive the plurality of interface inputs from each of a plurality of users, to map the plurality of interface inputs into the respective plurality of computer input commands associated with a native schema of a computer system, and to aggregate the plurality of computer input commands associated with a respective plurality of the users into a multi-modal event command configured to implement the predetermined function associated with the computer system.

11. A federated mission management system comprising a federated system manager that comprises the computer input system of claim 1, the computer input system being configured to receive the plurality of interface inputs from each of a plurality of input systems associated with at least one user, federated system manager further comprising:
a federated system processing system configured to receive inputs associated with situational awareness data from at least one mission asset and to provide outputs associated with controlling the at least one mission asset based on the predetermined function associated with the computer system; and
a display system configured to display mission status information regarding the at least one mission asset operating in a geographic region of interest.

12. A method for providing input to a computer system, the method comprising:
converting a first physical input action provided by a user in a first input mode via a first interface device into a first interface input based on a first application programming interface (API) associated with the first interface device;
mapping the first interface input to a first computer input command associated with a native schema of the computer system;
converting a second physical input action provided by the user in a second input mode via a second interface device into a second interface input based on a second API associated with the second interface device;
mapping the second interface input to a second computer input command associated with the native schema of the computer system;
aggregating the first computer input command and the second computer input command into a multi-modal event command; and
executing a single predetermined function associated with the respective computer system in response to the multi-modal event command.

13. The method of claim 12, wherein mapping the first and second interface inputs comprises comparing the first interface input and the second interface input with a plurality of computer input commands associated with the native schema of the respective computer system to determine the first computer input command and the second computer input command, respectively.

14. The method of claim 12, wherein aggregating the first and second computer input commands comprises:
beginning a modality timer in response to receiving one of the first and second computer input commands;
stopping the modality timer in response to receiving the other of the first and second computer input commands;
generating the multi-modal event command as a predetermined discrete computer computer input command in response to a timer value of the modality timer being less than a predetermined threshold.

15. The method of claim 12, wherein aggregating the first and second computer input commands comprises aggregating the first computer input command and the second computer input command into an activation command to initiate a sustained input event, the method further comprising:
converting a plurality of subsequent physical input actions provided by the user in at least one of the first input mode and the second input mode via a second interface device into a respective plurality of subsequent interface inputs during the sustained input event
mapping the plurality of subsequent interface inputs to a plurality of subsequent computer input commands associated with the native schema of the computer system during the sustained input event; and
terminating the sustained input event in response to a termination physical input action.

16. The method of claim 15, wherein terminating the sustained input event comprises at least one of:
terminating the sustained input event in response to a termination command corresponding to a termination interface input provided by the user via the termination physical input action in one of the first and second input modes; and
terminating the sustained input event in response to expiration of an inactivity timer value with respect to a predetermined threshold based on a duration of inactivity between each of the plurality of subsequent computer input commands.

17. The method of claim 12, further comprising:
converting a third physical input action provided by the user in at least one of the first input mode, the second input mode, and a third input mode into a third interface input;
mapping the third interface input to a third computer input command associated with the native schema of a respective computer system;
wherein aggregating the first and second computer input commands comprises aggregating the first, second, and third computer input commands into the multi-modal event command.

18. The method of claim 12, wherein converting the first physical input action comprises converting the first physical input action provided by a first user in the first input mode via the first interface device into the first interface input based on the first API associated with the first interface device, and wherein converting the second physical input action comprises converting the second physical input action provided by a second user in the second input mode via the second interface device into the second interface input based on the second API associated with the second interface device.

19. A computer system comprising:
a processor;
a plurality of ports that are each coupled to one of a respective plurality of interface devices configured to receive user physical interaction provided in one of a respective plurality of disparate input modes;
a multi-modal input system comprising:
a deconfliction engine configured to convert the user physical interaction associated with each of the plurality interface devices into a respective plurality of interface inputs via a plurality of application programming interfaces (APIs) associated with the respective plurality of interface devices, and to map the plurality of interface inputs into a respective plurality of computer input commands associated with a native schema of the computer system;
a multi-modal command aggregation controller configured to aggregate the plurality of computer input commands into a multi-modal event command based on comparing a timer value associated with a modality timer with a predetermined threshold timer value; and
a processor configured to execute a single predetermined function associated with the computer system in response to the multi-modal event command, such that the processor is configured to execute the single predetermined function associated with the computer system in response to user physical interaction provided in at least two of the plurality of disparate input modes.

20. The system of claim 19, wherein the multi-modal event command is an activation command configured to initiate a sustained input event in which each of a plurality of successive interface inputs are mapped to a respective plurality of successive computer input commands to implement a respective plurality of predetermined functions associated with the computer system during the sustained input event, wherein the sustained input event is terminated in response to a termination computer input command based on a termination action provided via the user or in response to expiration of an inactivity timer between the plurality of successive computer input commands.
